(19) United States
(12) Patent Application Publication
(10) Pub. No.: US 2024/0170796 A1
(43) Pub. Date: May 23, 2024

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nobuyuki MATSUMURA, Osaka (JP); Shinichi TAKASE, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/279,284

(22) PCT Filed: Mar. 11, 2022
(86) PCT No.: PCT/JP2022/010858

§ 371 Date: Aug. 29, 2023

(30) Foreign Application Priority Data
Mar. 19, 2021 (JP) 2021-046125

(51) Int. Cl. H01M 50/298; H01M 50/581

(52) U.S. Cl. CPC H01M 50/298; H01M 50/581; H01M 2200/10

(57) ABSTRACT

A wiring module is attached to a plurality of power storage devices, electrode terminals of the plurality of power storage devices being arranged in two rows continuously in an aligning direction of the plurality of power storage devices, and the two rows of electrode terminals being separated from each other in a separation direction orthogonal to the aligning direction, the wiring module including: a first substrate that is flexible and has a plurality of first voltage detection lines on only one surface thereof, a second substrate that is flexible and has a plurality of second voltage detection lines on only one surface thereof, and a connector, the plurality of first voltage detection lines are folded an odd number of times, ends on one side of the first voltage detection lines are electrically connected to electrode terminals that form one row of the two rows of electrode terminals.

### TECHNICAL FIELD

The present disclosure relates to a wiring module.

### BACKGROUND ART

A wiring module that is attached to a plurality of power storage devices is conventionally known. In the wiring module, a plurality of voltage detection lines are provided on a flexible substrate. The plurality of voltage detection lines are electrically connected to electrode terminals of the power storage devices. The plurality of voltage detection lines are connected to a device, and the voltages of the power storage devices are detected by the device. As such a wiring module, the wiring module disclosed in International Publication No. 2014/024452 (Patent Document 1 below) is known, for example.

### CITATION LIST

### Patent Documents

Patent Document 1: International Publication No. 2014/024452

### SUMMARY OF INVENTION

### Technical Problem

Positive and negative electrode terminals of each power storage device may be formed separated from each other at two end portions in the width direction of the power storage device. Furthermore, as a result of a plurality of power storage devices being connected in series or in parallel, the potentials of the electrode terminals may differ for each power storage device in a complicated manner. In such a case, in the wiring module attached to the plurality of power storage devices, voltage detection lines respectively connected to the electrode terminals may be aligned in an order that is different from the order of the potentials of the electrode terminals connected to the voltage detection lines (see FIG. 4 of Patent Document 1).

On the other hand, there are cases where, inside the device that detects the voltages of the power storage device, the terminals of a circuit or a microcomputer for detecting the voltages are formed in the order of potential. In view of this, it is conceivable to rearrange, in the order of potential, the voltage detection lines that are arranged irrespective of potential.

It is conceivable to use jumper wires in order to arrange, on a flexible substrate, voltage detection lines in the order of potential, for example. However, this technique increases the number of components and wiring complexity, and may thus increase the manufacturing cost of the wiring-module.

### Solution to Problem

A wiring module according to the present disclosure is a wiring module that is attached to a plurality of power storage devices, electrode terminals of the plurality of power storage devices being arranged in two rows continuously in an aligning direction of the plurality of power storage devices, and the two rows of electrode terminals being separated from each other in a separation direction that is orthogonal to the aligning direction, the wiring module including: a first substrate that is flexible and has a plurality of first voltage detection lines on only one surface thereof, a second substrate that is flexible and has a plurality of second voltage detection lines on only one surface thereof, and a connector, the plurality of first voltage detection lines are folded an odd number of times, ends on one side of the first voltage detection lines are electrically connected to electrode terminals that form one row of the two rows of electrode terminals, ends on the other side of the first voltage detection lines are aligned in the separation direction in an order of potentials of the electrode terminals electrically connected thereto via the first voltage detection lines, and are electrically connected to the connector, the plurality of second voltage detection lines are not folded or are folded an even number of times, ends on one side of the second voltage detection lines are electrically connected to electrode terminals that form the other row of the two rows of electrode terminals, ends on the other side of the second voltage detection lines are aligned in the separation direction in an order of potentials of the electrode terminals electrically connected thereto via the second voltage detection lines, and are electrically connected to the connector, and the first voltage detection lines and the second voltage detection lines are connected to the connector from the same side in the aligning direction.

### Advantageous Effects of Invention

According to the present disclosure, it is possible to provide a wiring module in which voltage detection lines are arranged in the order of potential, at a low cost.

### BRIEF DESCRIPTION OF DRAWINGS

FIG. 1 is a plan view of a power storage module according to a first embodiment.

FIG. 2 is a plan view of a second substrate in a state of not being folded along any second fold portion.

FIG. 3 is a plan view of the second substrate in a state of being mountain-folded along one of the second fold portions.

FIG. 4 is a plan view showing connection between the second substrate and a plurality of power storage devices.

FIG. 5 is a plan view of a first substrate in a state of not being folded along a first fold portion.

FIG. 6 is a plan view showing connection between the first substrate and the plurality of power storage devices.

FIG. 7 is an enlarged plan view of a power storage module, showing a temperature measuring piece disposed at an intermediate position between power storage devices, and a surrounding region of the temperature measuring piece.

FIG. 8 is a schematic diagram of a cross-section taken along line A-A in FIG. 1.

FIG. 9 is a schematic diagram of a connector as viewed from the rear.

FIG. 10 is a schematic diagram of a connector according to a second embodiment as viewed from the rear.

FIG. 11 is a plan view of a power storage module according to a third embodiment.

### DESCRIPTION OF EMBODIMENTS

### Description of Embodiments of Present Disclosure

First, aspects of the present disclosure will be listed and described.
(1) A wiring module according to the present disclosure is a wiring module that is attached to a plurality of power storage devices, electrode terminals of the plurality of power storage devices being arranged in two rows continuously in an aligning direction of the plurality of power storage devices, and the two rows of electrode terminals being separated from each other in a separation direction that is orthogonal to the aligning direction, the wiring module including: a first substrate that is flexible and has a plurality of first voltage detection lines on only one surface thereof, a second substrate that is flexible and has a plurality of second voltage detection lines on only one surface thereof, and a connector, the plurality of first voltage detection lines are folded an odd number of times, ends on one side of the first voltage detection lines are electrically connected to electrode terminals that form one row of the two rows of electrode terminals, ends on the other side of the first voltage detection lines are aligned in the separation direction in an order of potentials of the electrode terminals electrically connected thereto via the first voltage detection lines, and are electrically connected to the connector, the plurality of second voltage detection lines are not folded or are folded an even number of times, ends on one side of the second voltage detection lines are electrically connected to electrode terminals that form the other row of the two rows of electrode terminals, ends on the other side of the second voltage detection lines are aligned in the separation direction in an order of potentials of the electrode terminals electrically connected thereto via the second voltage detection lines, and are electrically connected to the connector, and the first voltage detection lines and the second voltage detection lines are connected to the connector from the same side in the aligning direction.

With such a configuration, since the first substrate has the plurality of first voltage detection lines on only one surface thereof, and the second substrate has the plurality of second voltage detection lines on only one surface thereof, a flexible substrate that has conductive paths formed on only one surface thereof can be used as the first substrate and the second substrate, and it is possible to reduce the manufacturing cost of the wiring module. Since the plurality of first voltage detection lines are folded an odd number of times, and the plurality of second voltage detection lines are not folded or are folded an even number of times, the ends on the other side of the first voltage detection lines and the ends on the other side of the second voltage detection lines can be aligned in the separation direction in the order of potentials of the electrode terminals to which the first voltage detection lines and the second voltage detection lines are respectively connected.
(2) Preferably, the surface of the first substrate on which the ends on the other side of the first voltage detection lines are disposed and the surface of the second substrate on which the ends on the other side of the second voltage detection lines are disposed face each other.

With such a configuration, the first substrate and the second substrate can be easily mounted to the connector.
(3) Preferably, the first substrate includes a plurality of thermistor circuits on the surface of the first substrate on which the first voltage detection lines are disposed, ends on one side of the plurality of thermistor circuits are connected to a common ground potential, ends on the other side of the plurality of thermistor circuits are connected to the connector, and are disposed between the ground potential and an end on the other side of a first voltage detection line connected to an electrode terminal that has the lowest potential.

With such a configuration, the plurality of thermistor circuits are disposed on the same surface as the first voltage detection lines, and thus it is possible to use, as the first substrate, a flexible substrate that has conductive paths formed only on one surface thereof, and to reduce the manufacturing cost of the wiring module. In addition, the potentials of the ends on the other side of the plurality of thermistor circuits are relatively close to the potential of the first voltage detection line that has the lowest potential, and thus it is possible to suppress short-circuiting between the thermistor circuits and the first voltage detection lines.
(4) Preferably, the connector includes first terminals that are respectively connected to the ends on the other side of the first voltage detection lines and second terminals that are respectively connected to the ends on the other side of the second voltage detection lines, the first terminals are aligned in a row in the separation direction, and the second terminals are disposed at positions different from the first terminals in a direction in which the first substrate and the second substrate face each other, and are aligned in a row in the separation direction.

With such a configuration, the size of the connector can be reduced in the separation direction.
(5) Preferably, the connector includes first terminals that are connected to the ends on the other side of the first voltage detection lines, and second terminals that are connected to the ends on the other side of the second voltage detection line, the first terminals and the second terminals are aligned in a row in the separation direction, and the first terminals and the second terminals are alternately disposed in the separation direction, and are aligned in an order of potential.

With such a configuration, the size of the connector can be reduced in the direction in which the first substrate and the second substrate face each other.
(6) Preferably, the wiring module includes a protector that protects the first substrate and the second substrate.

With such a configuration, it is possible to protect the first substrate and the second substrate.

### Details of Embodiments of Present Disclosure

Embodiments of the present disclosure will be described below. The present disclosure is not limited to these examples, but is defined by the claims and intended to include all modifications within the meaning and scope equivalent to the claims.

### First Embodiment

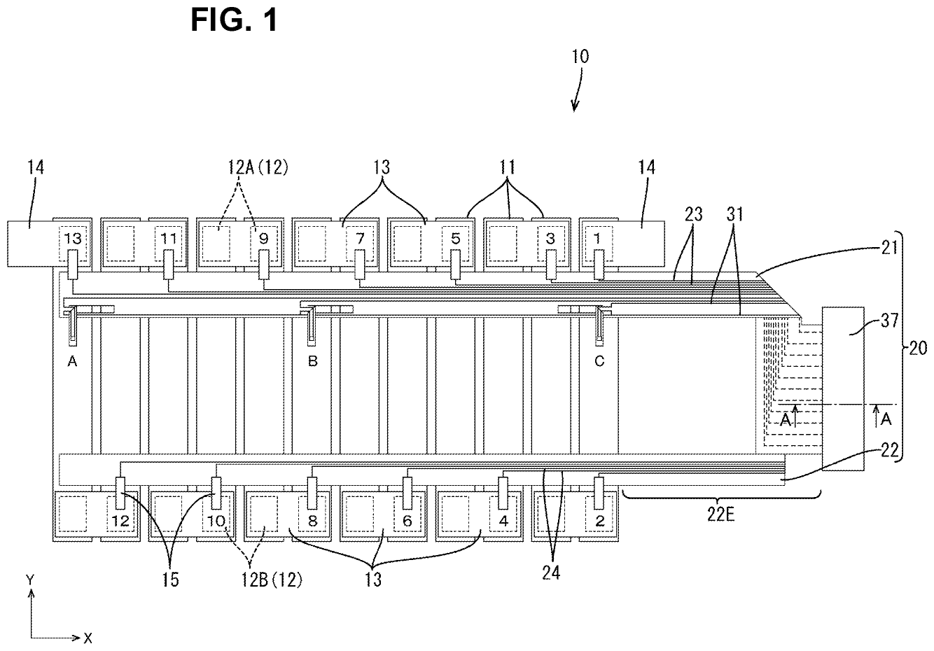

A first embodiment of the present disclosure will be described with reference to FIGS. 1 to 9. A power storage module 10 that includes a wiring module 20 according to the present embodiment is mounted in a vehicle such as an electric automobile, a hybrid automobile, or the like, as a power source for driving the vehicle. In the following description, the direction indicated by the arrow Z is regarded as the upward direction, the direction indicated by the arrow X is regarded as the forward direction, and the direction indicated by the arrow Y is regarded as the leftward direction. Note that only some of the same members are given reference numerals, and reference numerals of the other members may be omitted.

### Power Storage Devices

As shown in FIG. 1, in the power storage module 10, a plurality of (in the present embodiment, 12) power storage devices 11 are aligned in the front-rear direction (an example of an aligning direction). The power storage devices 11 each have a rectangular shape. An unshown power storage element is housed inside each power storage device 11. The power storage devices 11 are not particularly limited, and may be secondary batteries or capacitors. The power storage devices 11 according to the present embodiment are secondary batteries.

### Electrode Terminals

As shown in FIG. 1, electrode terminals 12 are formed on the left and right end portions of the upper surface of each of the power storage devices 11. One of the electrode terminals 12 is a positive electrode, and the other is a negative electrode. On the plurality of power storage devices 11, the electrode terminals 12 are arranged in two rows in the front-rear direction, and the two rows of electrode terminals 12 are separated from each other in the left-right direction (an example of a separation direction). Electrode terminals 12 that form one row of the two rows are referred to as “first electrode terminals 12A”, and are disposed on the left side of the plurality of power storage devices 11. Electrode terminals 12 that form the other row of the two rows are referred to as “second electrode terminals 12B”, and are disposed on the right side of the plurality of power storage devices 11. Connection bus bars 13 and output bus bars 14 are electrically connected to the first electrode terminals 12A. Connection bus bars 13 are electrically connected to the second electrode terminals 12B.

The connection bus bars 13 and the output bus bars 14 are obtained by pressing metal plates into predetermined shapes. A suitable metal such as copper, a copper alloy, aluminum, or an aluminum alloy can be appropriately selected as the metal used to form the metal plates. An unshown plating layer may be formed on the surfaces of the connection bus bars 13 and the output bus bars 14. A suitable metal such as tin, nickel, or solder can be selected as the metal for forming the plating layer.

As shown in FIG. 1, each connection bus bar 13 is connected to electrode terminals 12 that are adjacent to each other in the front-rear direction so as to bridge the electrode terminals 12. Each output bus bar 14 is connected to one electrode terminal 12 and outputs power to an external device. There are two output bus bars 14 in the present embodiment, one being connected to the first electrode terminal 12A of the rearmost power storage device 11 and the other being connected to the first electrode terminal 12A of the frontmost power storage device 11. In the present embodiment, five connection bus bars 13 each connect first electrode terminals 12A that are adjacent to each other, and six connection bus bars 13 each connect second electrode terminals 12B that are adjacent to each other. The plurality of power storage devices 11 are connected in series by these connection bus bars 13.

The electrode terminals 12 can be electrically connected to the output bus bars 14 and the connection bus bars 13 by employing a known technique such as soldering, welding, or bolting.

In FIG. 1, numerals “1” to “13” appended to the connection bus bars 13 and the output bus bars 14 indicate the ranks of the potentials of the electrode terminals 12 of the power storage devices 11 to which the connection bus bars 13 and the output bus bars 14 are connected. The potential of the electrode terminal 12 connected to the output bus bar 14 having the numeral “1” appended thereto is the highest, and the potentials decrease in order from “1” to “13”, the potential of the electrode terminal 12 connected to the output bus bar 14 having the numeral “13” appended thereto being the lowest.

As shown in FIG. 1, the ranks of the potentials of the first electrode terminals 12A connected to the output bus bars 14 and the connection bus bars 13 disposed on the left end portions of the plurality of power storage devices 11 aligned in the front-rear direction are “1”, “3”, “5”, “7”, “9”, “11”, and “13” in order from the highest potential. The ranks of the potentials of the second electrode terminals 12B connected to the connection bus bars 13 disposed on the right end portions of the plurality of power storage devices 11 are “2”, “4”, “6”, “8”, “10”, and “12” in order from the highest potential.

The power storage module 10 is connected to an external ECU (Electronic Control Unit) or the like (not shown) via a connector 37. The ECU has a microcomputer, devices, and the like mounted therein, and has a known configuration including functions for detecting the voltage, the current, the temperature, and the like of each power storage device 11, charge/discharge control of the power storage devices 11, and the like.

### Wiring Module

As shown in FIG. 1, the wiring module 20 is placed on the upper surfaces of the plurality of power storage devices 11. The wiring module 20 according to the present embodiment includes a first substrate 21 that is flexible and has a plurality of first voltage detection lines 23 on only one surface thereof, a second substrate 22 that is flexible and has a plurality of second voltage detection lines 24 on only one surface thereof, and the connector 37 to which the first substrate 21 and the second substrate 22 are connected. Out of the configurations of the first substrate 21 and the second substrate 22 that are substantially the same, the configuration of the second substrate 22, which is the simpler configuration, will be described below first, after which the configuration of the first substrate 21 will be described.

### Second Substrate

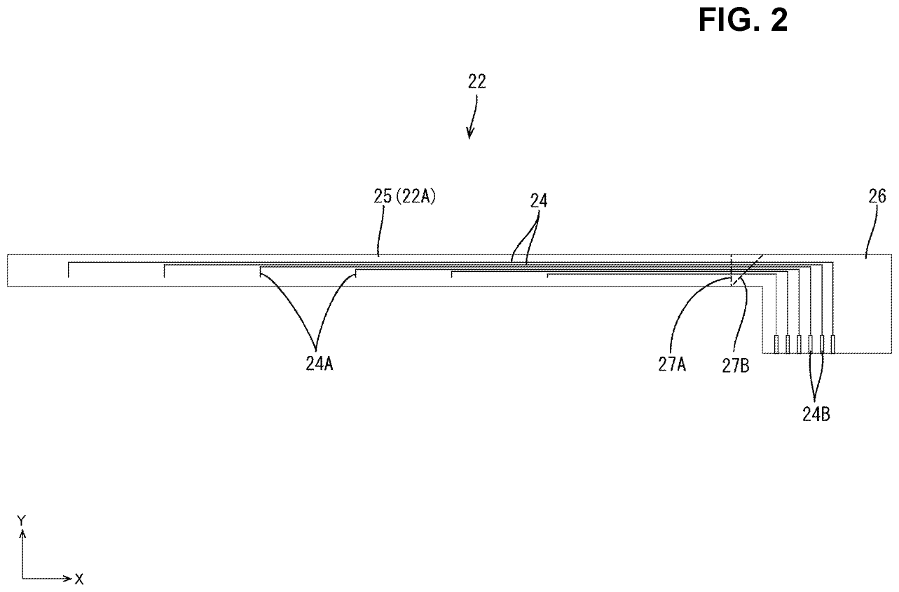

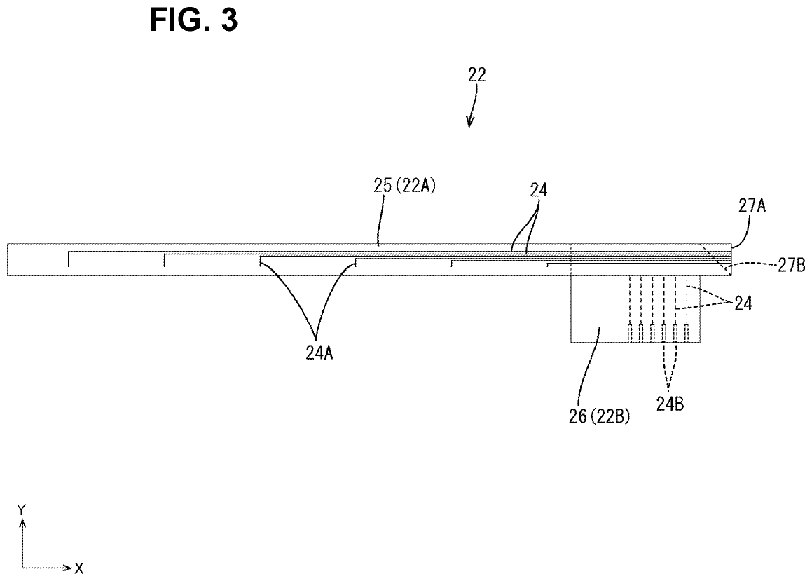

As shown in FIG. 2, the second substrate 22 is configured by forming the plurality of second voltage detection lines 24 on only a surface 22A of a flexible insulative sheet using printed wiring technology. As shown in FIG. 3, no conductive path is provided on a back surface 22B of the second substrate 22. Note that, on the back surface 22B of the second substrate 22, the second voltage detection lines 24 disposed on the surface 22A of the second substrate 22 are shown with broken lines (the same applies to the first substrate 21). The second substrate 22 according to the present embodiment is a flexible printed substrate.

### Second Voltage Detection Lines and Ends on One Side of Second Voltage Detection Lines

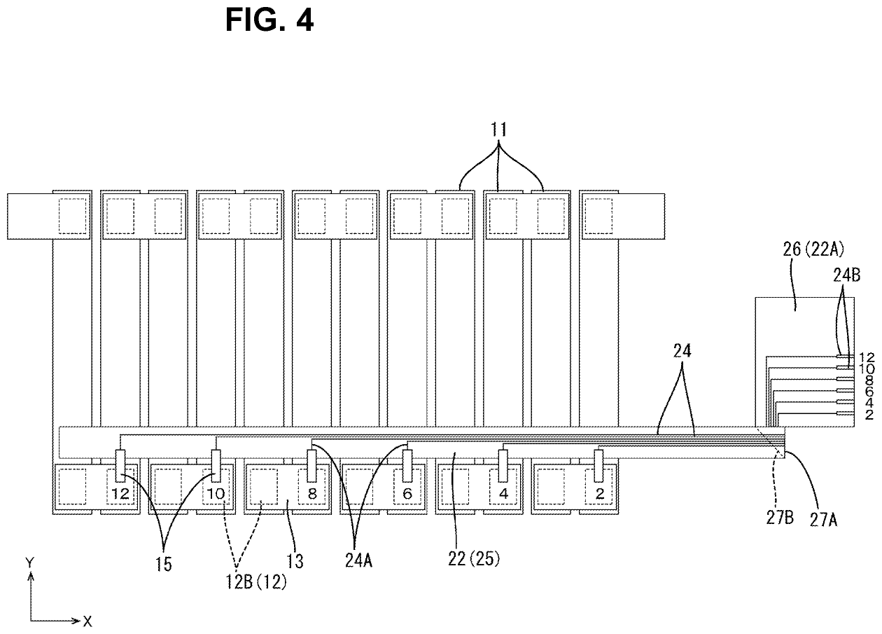

As shown in FIG. 4, a plurality of (in the present embodiment, six) second voltage detection lines 24 are formed on the second substrate 22. Ends 24A on one side of the second voltage detection lines 24 are the rear end portions of the second voltage detection lines 24. The ends 24A on the one side of the second voltage detection lines 24 are disposed on the right side of the second substrate 22 at intervals in the front-rear direction, and are respectively electrically connected to the connection bus bars 13 connected to the second electrode terminals 12B. The second voltage detection lines 24 can be electrically connected to the connection bus bars 13 by employing a suitable technique such as soldering or welding. In the present embodiment, the second voltage detection lines 24 are connected to the connection bus bars 13 via metal pieces 15 made of nickel or the like. The ends 24A on the one side of the second voltage detection lines 24 are connected to the metal pieces 15 through soldering, and the connection bus bars 13 are connected to the metal pieces through welding.

### Ends on Other Side of Second Voltage Detection Lines

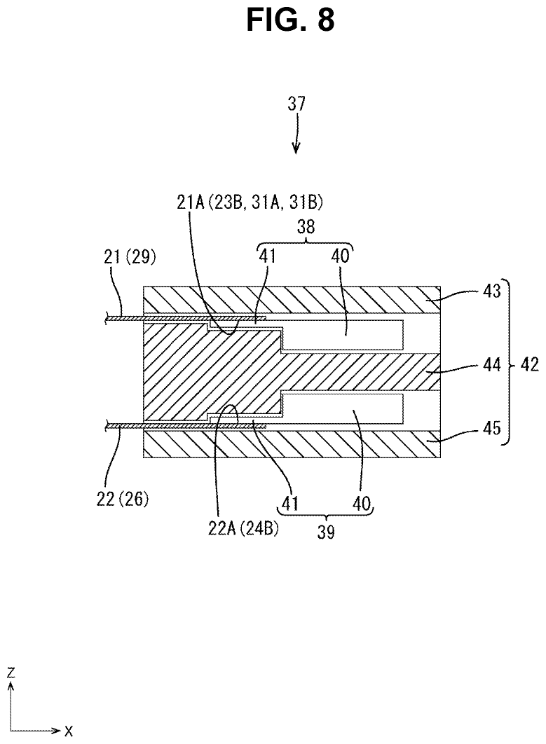

As shown in FIG. 4, the front end portions of the second voltage detection lines 24 are ends 24B on the other side of the second voltage detection lines 24. The ends 24B on the other side of the second voltage detection lines 24 are electrically connected to the connector 37 (see FIG. 8). In the present embodiment, the second voltage detection lines 24 are connected to the connector 37 through soldering.

As shown in FIG. 4, the second substrate 22 includes a routing portion 25 having a shape that is elongated in the front-rear direction as a whole and thus extends in the front-rear direction, a connector mounting portion 26 disposed at a front end portion of the second substrate 22, and second fold portions 27A and 27B along which the plurality of second voltage detection lines 24 are folded. A large portion of the routing portion 25 is placed on the upper surfaces of the plurality of power storage devices 11, and the routing portion 25 includes the ends 24A on the one side of the second voltage detection lines 24 that are connected to the second electrode terminals 12B. On the rear side of the routing portion 25 relative to the second fold portions 27A and 27B, the plurality of second voltage detection lines 24 extend substantially in the front-rear direction, and are aligned at intervals in the left-right direction.

On the second substrate 22 in a state of not being folded at the second fold portions 27A and 27B as shown in FIG. 2, the connector mounting portion 26 is disposed at an end portion of the routing portion 25, and is formed in a protruding shape that protrudes from the routing portion 25. In FIG. 2, the plurality of second voltage detection lines 24 disposed on the connector mounting portion 26 extend substantially in the left-right direction, and are aligned at intervals in the front-rear direction. The ends 24B on the other side of the second voltage detection lines 24 are disposed on a right end portion of the connector mounting portion 26.

As shown in FIG. 2, in a portion of the routing portion 25 that is close to the connector mounting portion 26, two second fold portions, namely the second fold portions 27A and 27B are provided spanning the entire width in the left-right direction of the routing portion 25. The second fold portion 27A is a fold line that extends at an angle of 90° relative to a direction in which the routing portion 25 extends, and the second fold portion 27B is a fold line that extends at an angle of 45° relative to a direction in which the routing portion 25 extends. The routing portion is mountain-folded at the second fold portion 27A (see FIGS. 2 and 3), and is valley-folded at the second fold portion 27B (see FIGS. 3 and 4). Here, mountain-folding is folding the routing portion 25 such that the fold line is disposed on the outside of the fold of the routing portion 25, and valley-folding is folding the routing portion 25 such that the fold line is disposed on the inside of the fold of the routing portion 25.

As shown in FIG. 4, the plurality of second voltage detection lines 24 are folded along two second fold portions, namely the second fold portions 27A and 27B, and the second voltage detection lines 24 are folded twice overall. Accordingly, the surface on which the ends 24B on the other side of the second voltage detection lines 24 are disposed (the surface 22A of the second substrate 22) is a surface on the upper side (on the near side in the vertical direction in FIG. 4). In addition, the second fold portion 27B is a fold line that extends at an angle of 45° relative to the direction in which the routing portion 25 extends, and thus, on the connector mounting portion 26, the second voltage detection lines 24 extend substantially in the front-rear direction, and are aligned at intervals in the left-right direction.

In FIG. 4, numerals appended to the ends 24B on the other side of the second voltage detection lines 24 indicate the potentials of the connection bus bars 13 (the second electrode terminals 12B) to which the second voltage detection lines 24 are connected. The ends 24B on the other side of the second voltage detection lines 24 are aligned in the left-right direction in descending order of potential, that is to say, in the order of “2”, “4”, “6”, “8”, “10”, and “12”, toward the left.

### First Substrate

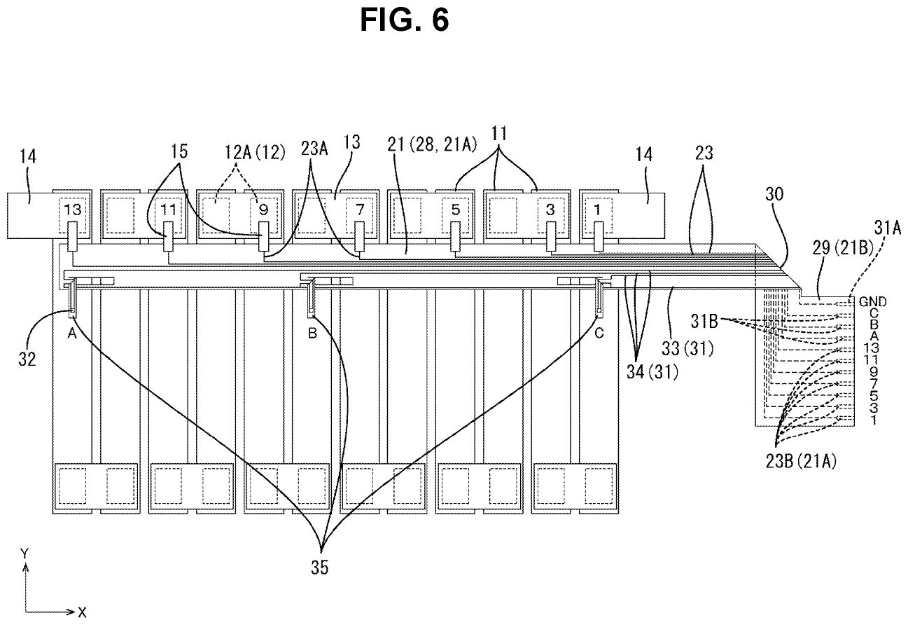

As shown in FIG. 6, the first substrate 21 has substantially the same configuration as the second substrate 22, and includes the plurality of first voltage detection lines 23, a routing portion 28, a connector mounting portion 29, and a first fold portion 30. Note that the configuration of the first fold portion 30 is different from those of the second fold portions 27A and 27B. In addition, the first substrate 21 further includes a plurality of thermistor circuits 31 that are not provided on the second substrate 22. The plurality of thermistor circuits 31 are circuits for measuring the temperatures of the power storage devices 11, and are formed only on the surface 21A of the first substrate 21 using printed wiring technology, similarly to the first voltage detection lines 23. The first substrate 21 according to the present embodiment is a flexible printed substrate.

First Voltage Detection Lines, Ends on One Side of First Voltage Detection Lines, and Ends on Other Side of First Voltage Detection Lines

As shown in FIG. 6, a plurality of (seven, in the present embodiment) first voltage detection lines 23 are formed on the first substrate 21. Ends 23A on one side of the first voltage detection lines 23 are rear end portions of the first voltage detection lines 23. The ends 23A on the one side of the first voltage detection lines 23 are disposed on the left side of the first substrate 21 at intervals in the front-rear direction, and are electrically connected to the connection bus bars 13 and the output bus bars 14 connected to the first electrode terminals 12A, via metal pieces 15. The ends 23B on the other side of the first voltage detection lines 23 are the front end portions of the first voltage detection lines 23. The ends 23B on the other side of the first voltage detection lines 23 are electrically connected to the connector 37 (see FIG. 8).

### Thermistor Circuits, Ends on One Side of Thermistor Circuit, and Ends on Other Side of Thermistor Circuit

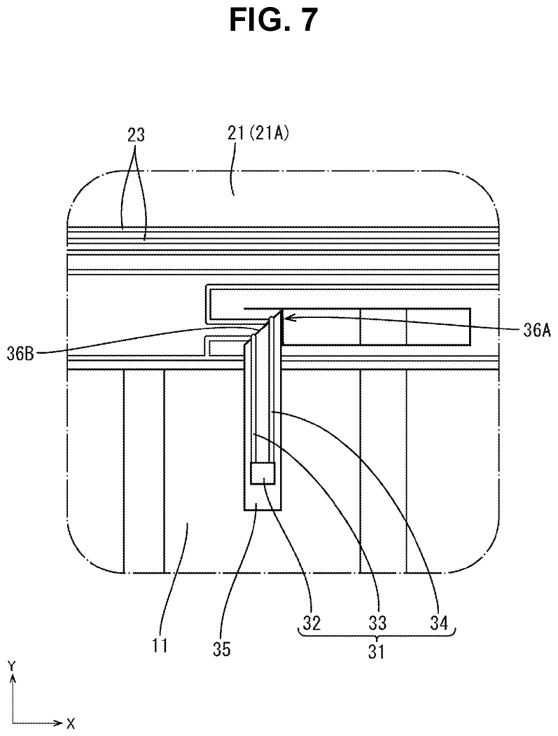

As shown in FIG. 6, a plurality of (in the present embodiment, three) thermistor circuits 31 are formed on the surface 21A of the first substrate 21 using printed wiring technology. The plurality of thermistor circuits 31 are disposed on the right side of the routing portion 28. As shown in FIG. 7, each thermistor circuit 31 includes a thermistor 32, a ground conductive path 33 that is led out from the thermistor 32 to a common ground potential, and a temperature measuring conductive path 34 that is led out from the thermistor 32, and is different from the ground conductive path 33. As shown in FIG. 6, the front end portion of a ground conductive path 33 is an end 31A on one side of the thermistor circuits 31, and the front end portions of the temperature measuring conductive paths 34 are ends 31B on the other side of the thermistor circuits 31.

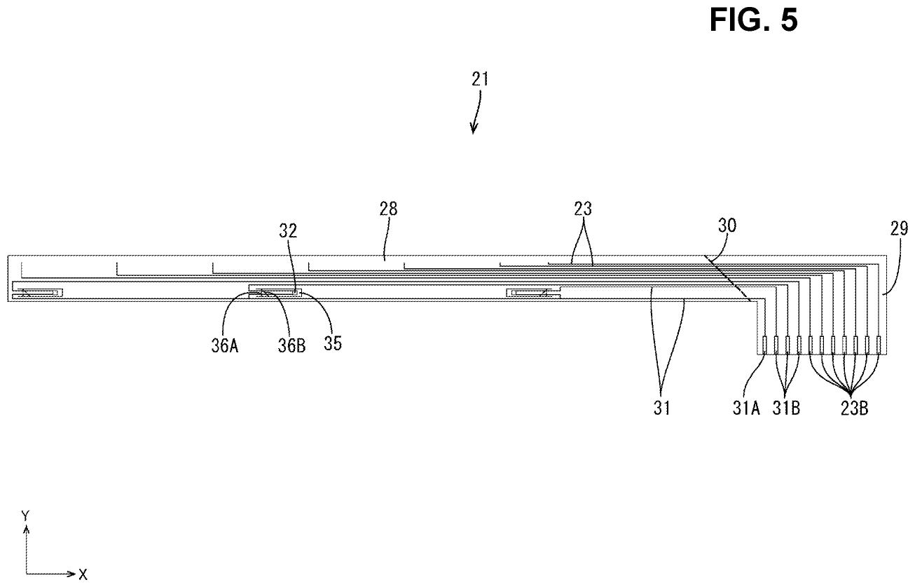

As shown in FIG. 6, a portion of a circuit that includes the thermistor 32 of the thermistor circuit 31 is disposed on a temperature measuring piece 35 provided on the first substrate 21. The temperature measuring pieces 35 are respectively provided on a rear portion and a front portion of the routing portion 28, and on an intermediate portion therebetween. Each temperature measuring piece 35 is formed by making a cut in the routing portion 28, and folding the cut portion toward a central portion in the left-right direction of the corresponding power storage device 11. As shown in FIGS. 5 and 7, specifically, the temperature measuring piece 35 includes two temperature measuring piece fold portions, namely temperature measuring piece fold portions 36A and 36B, and is valley-folded along the temperature measuring piece fold portion 36A and mountain-folded along the temperature measuring piece fold portion 36B. With such a configuration, as shown in FIG. 6, the plurality of thermistor circuits 31 make it possible to measure the temperatures in the vicinities of central portions in the left-right direction of the upper surfaces of the frontmost, rearmost, and intermediate power storage devices 11, among the plurality of power storage devices 11.

On the first substrate 21 in a state of not being folded along the first fold portion 30 as shown in FIG. 5, the plurality of first voltage detection lines 23 and the thermistor circuits 31 disposed on the connector mounting portion 29 extend substantially in the left-right direction, and are aligned at intervals in the front-rear direction. The ends 23B on the other side of the first voltage detection lines 23, the end 31A on one side of the thermistor circuit 31, and the ends 31B on the other side of the thermistor circuits 31 are disposed on a right end portion of the connector mounting portion 29.

As shown in FIG. 5, on a portion of the routing portion 28 that is close to the connector mounting portion 29, one first fold portion 30 is provided spanning the entire width in the left-right direction of the routing portion 28. The first fold portion is a fold line that extends at an angle of 45° relative to the direction in which the routing portion 28 extends. As shown in FIG. 6, the routing portion 28 is mountain-folded along the first fold portion 30.

As shown in FIG. 6, the plurality of first voltage detection lines 23 are folded along the first fold portion 30, and the first voltage detection lines 23 are folded once overall. Accordingly, the surface of the first substrate 21 on which the ends 23B on the other side of the first voltage detection lines 23 are disposed (the surface 21A) is a surface on the lower side (on the farther side in the vertical direction in FIG. 6). In other words, the connector mounting portion 29 illustrated in FIG. 6, makes a back surface 21B of the first substrate 21 face upward (on the nearside in the vertical direction in in FIG. 6). Similarly, the plurality of thermistor circuits 31 are also disposed on the surface on the lower side of the connector mounting portion 29. In addition, the first fold portion 30 is a fold line that extends at an angle of 45° relative to the direction in which the routing portion 28 extends, and thus the first voltage detection lines 23 and the thermistor circuits 31 on the connector mounting portion 29 extend substantially in the front-rear direction, and are aligned at intervals in the left-right direction.

As shown in FIG. 6, the ends 23B on the other side of the first voltage detection lines 23 are disposed close together from the right end of the connector mounting portion 29, and are aligned in the left-right direction in descending order of potential, that is to say, in the order of “1”, “3”, “5”, “7”, “9”, “11”, and “13”, toward the left. The potential of the first voltage detection line 23 to which “13” is appended is the lowest compared with the potentials of the other first voltage detection lines 23 and the second voltage detection lines 24. The potential of the first voltage detection line 23 to which “13” is appended serves as a reference in the power storage module according to the present embodiment, and may be 0 V. If the power storage module 10 according to the present embodiment and another power storage module are connected in series, the potential of the first voltage detection line 23 to which “13” is appended is based on a relative difference in potential from the other power storage module 10, and thus may be higher than 0 V.

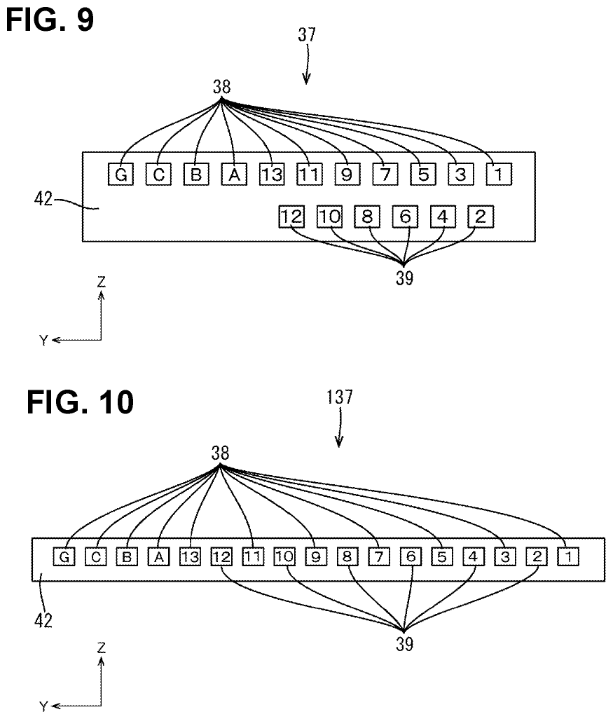

As shown in FIG. 6, the end 31A on the one side of the thermistor circuit 31 that is connected to the ground potential is disposed on the left side of the connector mounting portion 29. The reference sign “GND” (in FIG. 9, “G”) indicating a ground potential is appended to the end 31A on the one side of the thermistor circuit 31. The potential of the end 31A on the one side of the thermistor circuit 31 is the ground potential, that is to say, 0 V. The ends 31B on the other side of the thermistor circuits 31 are disposed on the right side of the end 31A on one side of the thermistor circuit 31. The reference signs “C”, “B”, and “A” are appended to the ends 31B on the other side of the thermistor circuits 31 in order from the left, corresponding to the thermistors 32 disposed on the frontmost, intermediate, and rearmost power storage devices 11, respectively. The potential of the ends 31B on the other side of the thermistor circuits 31 depends on the resistance values of the thermistors 32.

As shown in FIG. 6, on the connector mounting portion 29, the ends 31B on the other side of the plurality of thermistor circuits 31 to which the reference signs “A”, “B”, and “C” are appended are disposed between the end 31A on the one side of the thermistor circuit 31 to which the reference sign “GND” (ground potential) is appended, and the end 23B on the other side of the first voltage detection line 23 to which “13” is appended and that has the lowest potential. The potentials of the ends 31B on the other side of the thermistor circuits 31 are relatively close to the potential of the end 23B on the other side of the first voltage detection line 23 that is the lowest, and thus it is possible to suppress short-circuiting between the thermistor circuits 31 and the first voltage detection lines 23.

### Connector

As shown in FIG. 8, the connector mounting portion 29 of the first substrate 21 and the connector mounting portion 26 of the second substrate 22 are connected to the connector 37 from the rear side (an example of the same side in the aligning direction). An arrangement is adopted in which the surface 21A of the first substrate 21 on which the ends 23B on the other side of the first voltage detection lines 23 are disposed and the surface 22A of the second substrate 22 on which the ends 24B on the other side of the second voltage detection lines 24 are formed face each other in the up-down direction (an example of an opposing direction).

As shown in FIG. 8, the connector 37 according to the present embodiment is a connector for a flexible printed substrate, and includes first terminals 38 that are connected to the first substrate 21, second terminals 39 that are connected to the second substrate 22, and a housing 42 that accommodates the first terminals 38 and the second terminals 39. In the present embodiment, the first terminals 38 and the second terminals 39 are female terminals. The first terminals 38 and the second terminals 39 each include a tubular connection portion 40 that is connected to a male terminal of a partner connector (not shown), and a substrate connection portion 41 that is continuous to the tubular connection portion 40 on the rear side thereof. The substrate connection portion 41 of each first terminal 38 is connected to the end 23B on the other side of a first voltage detection line 23, the end 31A on the one side of a thermistor circuit 31, or the end 31B on the other side of a thermistor circuit 31 through soldering. The substrate connection portions 41 of the second terminals 39 are connected to the ends 24B on the other side of the second voltage detection lines 24 through soldering.

As shown in FIG. 8, for example, the housing 42 includes a separate upper housing 43, a lower housing 45, and an intermediate housing 44 disposed therebetween. The upper housing 43 constitutes the outer surface on the upper side of the housing 42, and the lower housing 45 constitutes the outer surface on the lower side of the housing 42. The intermediate housing 44 engages with and retains the first terminals 38 and the second terminals 39, inside the housing 42. Although a detailed description is omitted, the connector 37 can be configured by attaching the upper housing 43, the first substrate 21 connected to the first terminals 38 through soldering in advance, the intermediate housing 44, the second substrate 22 connected to the second terminals 39 through soldering in advance, and the lower housing 45 to one another in a layered manner in the up-down direction, for example.

FIG. 9 is a rear view of the connector 37 schematically showing the arrangement of the first terminals 38 and the second terminals 39 on the connector 37. The numerals “1” to “13” appended inside the square frames indicating the first terminals 38 and the second terminals 39 represent the ranks of the potentials of the first terminals 38 and the second terminals 39, and correspond to the numerals appended to the connection bus bars 13 and the output bus bars 14 in FIG. 1. Similarly, the reference signs “G”, “C”, “B”, and “A” appended to the first terminals 38 in FIG. 9 correspond to the reference signs “GND”, “C”, “B”, and “A” appended to the end 31A on the one side of the thermistor circuit 31 and the ends 31B on the other side of the thermistor circuits 31 in FIG. 6.

As shown in FIG. 9, on the upper side of the connector 37, the first terminals 38 are aligned in a row in the left-right direction in the order of potential. On the lower side of the connector 37, the second terminals 39 are aligned in a row in the left-right direction in the order of potential. As a result of the first terminals 38 and the second terminals 39 being displaced relative to each other in the up-down direction and the connector 37 having a two-level configuration in this manner, the size of the connector 37 can be reduced in the left-right direction. Particularly when the number of power storage devices 11 to which the wiring module 20 is applied is large, the number of first voltage detection lines 23 and second voltage detection lines 24 is large, and thus there are cases where a two-level configuration such as that of the connector 37 is preferable.

In FIG. 9, each second terminal 39 is disposed at an intermediate position between first terminals 38 that are adjacent in the left-right direction, the second terminals 39 being connected to a potential therebetween. The second terminal 39 to which “6” is appended is disposed at an intermediate position in the left-right direction between the first terminals 38 to which “5” and “7” are appended, for example. As a result of the first terminals 38 and the second terminals 39 being displaced relative to each other in the left-right direction in this manner, the first terminals 38 and the second terminals 39 can be aligned in a zig-zag manner in the left-right direction in the order of potential, on the connector 37 as a whole (that is to say, including the upper level and the lower level).

In addition, positions at which the first terminals 38 and the second terminals 39 are disposed in the left-right direction may be aligned (not illustrated) unlike the arrangement in FIG. 9. A configuration may also be adopted in which, for example, the first terminal 38 to which “1” is appended and the second terminal 39 to which “2” is appended are disposed at the same position in the left-right direction, and the first terminal 38 to which “3” is appended and the second terminal 39 to which “4” is appended are disposed at the same position in the left-right direction.

### Operations and Effects of First Embodiment

According to the first embodiment, the following operations and effects are achieved.

The wiring module 20 according to the first embodiment is a wiring module that is attached to the plurality of power storage devices 11, the electrode terminals 12 of the plurality of power storage devices 11 being arranged in two rows continuously in the front-rear direction, and the two rows of electrode terminals 12 being separated from each other in the left-right direction, the wiring module 20 including: the first substrate 21 that is flexible and has the plurality of first voltage detection lines 23 on only one surface thereof, the second substrate 22 that is flexible and has the plurality of second voltage detection lines 24 on only one surface thereof, and the connector 37, the plurality of first voltage detection lines 23 are folded once, the ends 23A on the one side of the first voltage detection lines 23 are electrically connected to first electrode terminals 12A that form one row of the two rows of electrode terminals 12, the ends 23B on the other side of the first voltage detection lines 23 are aligned in the left-right direction in the order of potentials of the first electrode terminals 12A electrically connected thereto via the first voltage detection lines 23, and are electrically connected to the connector 37, the plurality of second voltage detection lines 24 are folded twice, the ends 24A on the one side of the second voltage detection lines 24 are electrically connected to second electrode terminals 12B that form the other row, the ends 24B on the other side of the second voltage detection lines 24 are aligned in the left-right direction in the order of potentials of the second electrode terminals 12B electrically connected thereto via the second voltage detection lines 24, and are electrically connected to the connector 37, and the first voltage detection lines 23 and the second voltage detection lines 24 are connected to the connector 37 from the rear side.

According to the above configuration, the first substrate 21 has the plurality of first voltage detection lines 23 on only one surface thereof, and the second substrate 22 has the plurality of second voltage detection lines 24 on only one surface thereof, and thus, a flexible substrate that has conductive paths formed only on one surface thereof (flexible printed substrate) can be used as the first substrate 21 and the second substrate 22, and it is possible to reduce the manufacturing cost of the wiring module 20. Since the plurality of first voltage detection lines 23 are folded once and the plurality of second voltage detection lines 24 are folded twice, the ends 23B on the other side of the first voltage detection lines 23 and the ends 24B on the other side of the second voltage detection lines 24 can be aligned in the left-right direction in the order of potentials of the electrode terminals 12 to which the first voltage detection lines 23 and the second voltage detection lines 24 are respectively connected.

In the first embodiment, the surface of the first substrate 21 on which the ends 23B on the other side of the first voltage detection lines 23 are disposed and the surface of the second substrate 22 on which the ends 24B on the other side of the second voltage detection lines 24 are disposed face each other.

According to the above configuration, the first substrate 21 and the second substrate 22 can be easily mounted to the connector 37.

In the first embodiment, the first substrate 21 includes the plurality of thermistor circuits 31 on the surface thereof on which the first voltage detection lines 23 are disposed, the end 31A on the one side of the plurality of thermistor circuit 31 is connected to the common ground potential, and the ends 31B on the other side of the plurality of thermistor circuits 31 are connected to the connector 37, and are disposed between the ground potential and the end 23B on the other side of the first voltage detection line 23 connected to the electrode terminal 12 that has the lowest potential.

According to the above configuration, the plurality of thermistor circuits 31 are disposed on the same surface as the first voltage detection lines 23, and thus a flexible substrate that has conductive paths formed on only one surface thereof (flexible printed substrate) can be used as the first substrate 21, and it is possible to reduce the manufacturing cost of the wiring module 20. In addition, the potentials of the ends 31B on the other side of the plurality of thermistor circuits 31 are relatively close to the potential of the first voltage detection line 23 that is the lowest, and thus it is possible to suppress short-circuiting between the plurality of thermistor circuits 31 and the first voltage detection lines 23.

In the first embodiment, the connector 37 includes the first terminals 38 that are connected to the ends 23B on the other side of the first voltage detection lines 23, and the second terminals 39 that are connected to the ends 24B on the other side of the second voltage detection lines 24, and the first terminals 38 are aligned in a row in the left-right direction, and the second terminals 39 are disposed at different positions from the first terminal 38 in the up-down direction, and are aligned in a row in the left-right direction.

According to the above configuration, the size of the connector 37 can be reduced in the left-right direction.

### Second Embodiment

A second embodiment of the present disclosure will be described with reference to FIG. 10. A configuration according to the second embodiment is the same as the configuration according to the first embodiment except that a connector 137 has a single-level configuration. Hereinafter, the same members as those in the first embodiment are given the same reference numerals used in the first embodiment, and a description of the same configurations, operations, and effects as those in the first embodiment is omitted.

FIG. 10 is a rear view of the connector 137 schematically showing the arrangement of the first terminals 38 and the second terminals 39 on the connector 137 according to the second embodiment. Unlike the connector 37 according to the first embodiment (see FIGS. 8 and 9), the connector 137 is configured by aligning the first terminals 38 and the second terminals 39 in a single row in the left-right direction. That is to say, the connector 137 has a single-level arrangement. By adopting the single-level arrangement, the size of the connector 137 can be reduced in the up-down direction. Particularly when the number of power storage devices 11 to which the wiring module 20 is applied is small, the number of first voltage detection lines 23 and second voltage detection lines 24 is small, and thus there are cases where a single-level configuration such as that of the connector 137 can be adopted. As shown in FIG. 10, on the connector 137, the first terminals 38 and the second terminals 39 are alternately disposed in the left-right direction, and the first terminals 38 and the second terminals 39 are aligned in the left-right direction in the order of potential. In other words, the first terminals 38 and the second terminals 39 are aligned in descending order of potential, that is to say, in the order of “1”, “2”, “3”, “4”, “5”, “6”, “7”, “8”, “9”, “10”, “11”, “12”, and “13, toward the left.

### Operations and Effects of Second Embodiment

According to the second embodiment, the following operations and effects are achieved.

In the second embodiment, the connector 137 includes the first terminals 38 that are connected to the ends 23B on the other side of the first voltage detection lines 23 and the second terminals 39 that are connected to the ends 24B on the other side of the second voltage detection lines 24, the first terminals 38 and the second terminals 39 are aligned in a row in the left-right direction, and the first terminals 38 and the second terminals 39 are disposed alternately in the left-right direction, and are aligned in the order of potential.

According to the above configuration, the size of the connector 137 can be reduced in the up-down direction.

### Third Embodiment

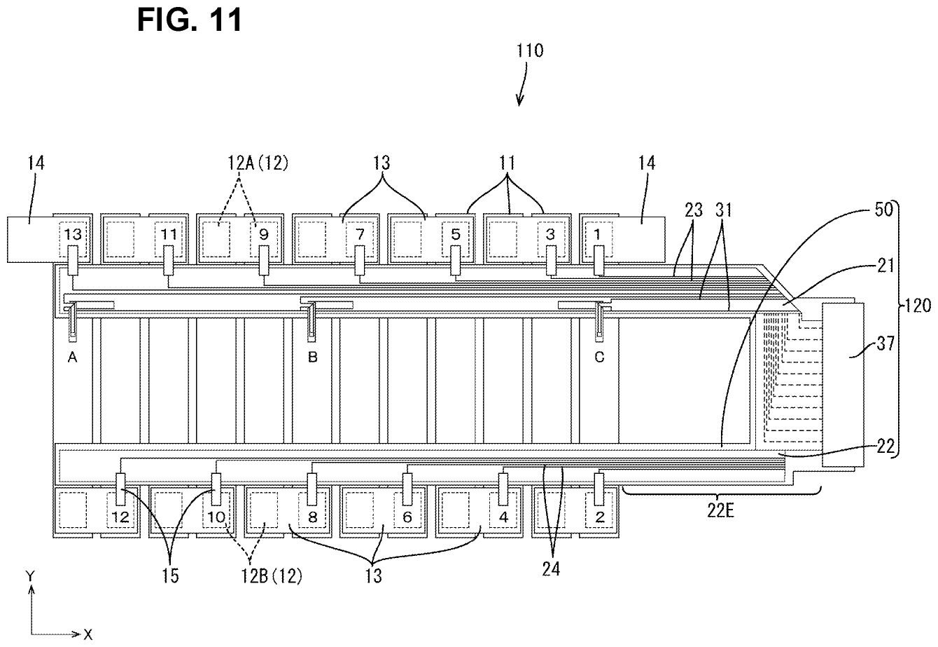

A third embodiment of the present disclosure will be described with reference to FIG. 11. The configuration of a wiring module 120 of a power storage module 110 according to the third embodiment is the same as the configuration of the wiring module 20 according to the first embodiment except that a protector 50 is provided. Hereinafter, the same members as those in the first embodiment are given the same reference numerals used in the first embodiment, and a description of the same configurations, operations, and effects as those in the first embodiment is omitted.

As shown in FIG. 11, the protector 50 is a plate-like member made of an insulative synthetic resin. The protector 50 is configured to hold the first substrate 21, the second substrate 22, and the connector 37. Although a state where the protector 50 holds the first substrate 21, the second substrate 22, and the connector 37 is not illustrated, fixing involving an adhesive, engagement that uses an engagement structure, and the like can be adopted, for example.

The wiring module 120 includes the protector 50, and thus members thereof can be protected. In the configuration according to the first embodiment in which no protector 50 is provided, as shown in FIG. 1, portions of the first substrate 21 and the second substrate 22 (hereinafter, referred to as “extended portions 22E”) extending on the front side relative to the plurality of power storage devices 11 are exposed to the outside, and are thus likely to be damaged, particularly when subjected to a force from the outside. However, in the second embodiment, as shown in FIG. 11, the extended portions 22E are protected by the protector 50, and are not exposed to the outside. Therefore, it is possible to suppress damage to the extended portions 22E caused by an external force. In addition, by providing the protector 50, attachment, transportation, and the like of the wiring module 120 are made easy.

### Operations and Effects of Third Embodiment

According to the third embodiment, the following operations and effects are achieved.

The wiring module 120 according to the third embodiment includes the protector 50 that protects the first substrate 21 and the second substrate 22.

According to the above configuration, it is possible to protect the first substrate 21 and the second substrate 22.

### OTHER EMBODIMENTS

(1) In the above embodiments, the first terminals 38 and the second terminals 39 are female terminals, but there is no limitation thereto, and the first terminals and the second terminals may be male terminals.
(2) In the above embodiments, the surface of the first substrate 21 on which the ends 23B on the other side of the first voltage detection lines 23 are disposed (the surface 21A) and the surface of the second substrate 22 on which the ends 24B on the other side of the second voltage detection lines 24 are disposed (the surface 22A) face each other, but there is no limitation thereto, and the back surface of the first substrate and the back surface of the second substrate may face each other.
(3) In the above embodiments, the thermistor circuits 31 are provided, but there is no limitation thereto, and no thermistor circuits need to be provided.
(4) In the above embodiments, the connectors 37 and 137 have a configuration in which the separate upper housing 43, the intermediate housing 44, the lower housing 45, the first substrate 21 to which the first terminals 38 are connected, and the second substrate 22 to which the second terminals 39 are connected are attached to one another in a layered manner, but there is no limitation thereto. A configuration may also be adopted in which, for example, first terminals and second terminals are attached to an integrated housing to configure a connector, and the connector is then mounted to the first substrate and the second substrate.
(5) In the above embodiments, no reinforcing plate is attached to the opposite surface (the back surface 21B) to the surface of the first substrate 21 on which the first terminals 38 are connected to the connector mounting portion 29 or the opposite surface (the back surface 22B) to the surface of the second substrate 22 on which the second terminals 39 are connected to the connector mounting portion 26, but there is no limitation thereto, and reinforcing plates may be attached to the back surfaces of connector mounting portions.
(6) In the above embodiments, the first substrate 21 and the second substrate 22 are flexible printed substrates, but there is no limitation thereto, and one of or both the first substrate and the second substrate may be a flexible flat cable.

### LIST OF REFERENCE NUMERALS

10, 110: Power storage module
11: Power storage device
12: Electrode terminal
12A: First electrode terminal
12B: Second electrode terminal
13: Connection bus bar
14: Output bus bar
15: Metal piece
20, 120: Wiring module
21: First substrate
21A: Surface
22: Second substrate
22A: Surface
22B: Back surface
22E: Extended portion
23: First voltage detection line
23A: End on one side
23B: End on other side
24: Second voltage detection line
24A: End on one side
24B: End on other side
25: Routing portion
26: Connector mounting portion
27A, 27B: Second fold portion
28: Routing portion
29: Connector mounting portion
30: First fold portion
31: Thermistor circuit
31A: End on one side
31B: End on other side
32: Thermistor
33: Ground conductive path
34: Temperature measuring conductive path
35: Temperature measuring piece
36A, 36B: Temperature measuring piece fold portion
37, 137: Connector
38: First terminal
39: Second terminal
40: Tubular connection portion
41: Substrate connection portion
42: Housing
43: Upper housing
44: Intermediate housing
45: Lower housing
50: Protector

1. A wiring module that is attached to a plurality of power storage devices, electrode terminals of the plurality of power storage devices being arranged in two rows continuously in an aligning direction of the plurality of power storage devices, and the two rows of electrode terminals being separated from each other in a separation direction that is orthogonal to the aligning direction, the wiring module comprising:
a first substrate that is flexible and has a plurality of first voltage detection lines on only one surface thereof;
a second substrate that is flexible and has a plurality of second voltage detection lines on only one surface thereof; and
a connector,
wherein the plurality of first voltage detection lines are folded an odd number of times,
ends on one side of the first voltage detection lines are electrically connected to electrode terminals that form one row of the two rows of electrode terminals,
ends on the other side of the first voltage detection lines are aligned in the separation direction in an order of potentials of the electrode terminals electrically connected thereto via the first voltage detection lines, and are electrically connected to the connector,
the plurality of second voltage detection lines are not folded or are folded an even number of times,
ends on one side of the second voltage detection lines are electrically connected to electrode terminals that form the other row of the two rows of electrode terminals,
ends on the other side of the second voltage detection lines are aligned in the separation direction in an order of potentials of the electrode terminals electrically connected thereto via the second voltage detection lines, and are electrically connected to the connector, and
the first voltage detection lines and the second voltage detection lines are connected to the connector from the same side in the aligning direction.

2. The wiring module according to claim 1,
wherein the surface of the first substrate on which the ends on the other side of the first voltage detection lines are disposed and the surface of the second substrate on which the ends on the other side of the second voltage detection lines are disposed face each other.

3. The wiring module according to claim 1,
wherein the first substrate includes a plurality of thermistor circuits on the surface of the first substrate on which the first voltage detection lines are disposed,
ends on one side of the plurality of thermistor circuits are connected to a common ground potential, and
ends on the other side of the plurality of thermistor circuits are connected to the connector, and are disposed between the ground potential and an end on the other side of a first voltage detection line connected to an electrode terminal that has the lowest potential.

4. The wiring module according to claim 1,
wherein the connector includes first terminals that are respectively connected to the ends on the other side of the first voltage detection lines and second terminals that are respectively connected to the ends on the other side of the second voltage detection lines,
the first terminals are aligned in a row in the separation direction, and
the second terminals are disposed at positions different from the first terminals in a direction in which the first substrate and the second substrate face each other, and are aligned in a row in the separation direction.

5. The wiring module according to claim 1,
wherein the connector includes first terminals that are connected to the ends on the other side of the first voltage detection lines, and second terminals that are connected to the ends on the other side of the second voltage detection lines,
the first terminals and the second terminals are aligned in a row in the separation direction, and
the first terminals and the second terminals are alternately disposed in the separation direction, and are aligned in an order of potential.

6. The wiring module according to claim 1, further comprising
a protector that protects the first substrate and the second substrate.
